(19) United States
(12) Patent Application Publication
(10) Pub. No.: US 2026/0292489 A1
(43) Pub. Date: Sep. 24, 2026

(54) USER EQUIPMENT (UE) ACCESS SUPPORT FOR A STANDALONE NON-PUBLIC NETWORK(SNPN)

(71) Applicant: LENOVO (SINGAPORE) PTE. LTD., Singapore (SG)

(72) Inventors: Andreas KUNZ, Ladenburg (DE); Sheeba Backia Mary BASKARAN, Friedrichsdorf (DE)

(21) Appl. No.: 19/126,072

(22) PCT Filed: Nov. 2, 2023
(86) PCT No.: PCT/IB2023/061073

§ 371 Date: Apr. 30, 2025

Related U.S. Application Data
(60) Provisional application No. 63/382,455, filed on Nov. 4, 2022.

(51) Int. Cl. H04W 12/0431; H04L 12/06; H04W 12/02; H04W 12/71

(52) U.S. Cl. CPC H04W 12/0431; H04L 12/06; H04W 12/02; H04W 12/71

(57) ABSTRACT

Various aspects of the present disclosure relate to adaptation of procedures established for both trusted non-3GPP access and untrusted non-3GPP access. For example, network nodes (e.g., TNGF and N3IWF) can assign or generate an identifier for a UE having an anonymous SUCI as a username during the access procedure. Using the assigned identifier, the network entity can bind or associate the UE to a security key, and communications with the UE within the SNPN can be correlated.

### CROSS REFERENCE TO RELATED APPLICATIONS

This application claims priority to U.S. Provisional Patent Application No. 63/382,455 filed on Nov. 4, 2022, entitled USER EQUIPMENT (UE) ACCESS SUPPORT FOR A STANDALONE NON-PUBLIC NETWORK (SNPN), which is hereby incorporated by reference in its entirety.

### TECHNICAL FIELD

The present disclosure relates to wireless communications, and more specifically to supporting access to a Standalone Non-Public Network (SNPN).

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A Non-Public Network (NPN) facilitates the deploying of the 5G access technology for private uses or environments, such as a network dedicated to a single organization. One type of NPN is an SNPN, which is operated by an NPN operator and provides its own network functions without utilizing network functions provided by a PLMN, or Public Land Mobile Network.

### SUMMARY

The present disclosure relates to methods, apparatuses, and systems that support adaptation of procedures established for both trusted non-3GPP access and untrusted non-3GPP access. For example, network nodes, such as a Trusted Non-3GPP Gateway Function (TNGF) and/or a non-3GPP Inter-Working Function (N3IWF), can assign or generate an identifier for a UE having an anonymous Subscription Concealed Identifier (SUCI) as a username during the access procedure. Using the assigned identifier, the network entity can bind or associate the UE to a security key, and communications with the UE within the SNPN can be correlated.

Some implementations of the method and apparatuses described herein may further include a network entity comprising a processor and a memory coupled with the processor, the processor configured to cause the network entity to receive, from a network function, a security key for a remote device, assign an internet protocol (IP) address to the remote device, associate the security key to the IP address assigned to the remote device, and store the association of the IP address and the security key.

In some implementations of the method and apparatuses described herein, the processor is further configured to cause the network entity to receive, from the remote device, a message requesting setup of a security association where the message includes the IP address as an identifier for the remote device, and select the security key based on the IP address.

In some implementations of the method and apparatuses described herein, the message requesting setup of the security association includes an IKE_INIT message or an IKE-AUTH message.

In some implementations of the method and apparatuses described herein, the message requesting setup includes an anonymous SUCI as the identifier for the remote device that was provided to the network entity during prior EAP-5G (Extensible Authentication Protocol 5G) signaling.

In some implementations of the method and apparatuses described herein, the network entity is a TNGF of an SNPN.

In some implementations of the method and apparatuses described herein, the network function is an Access and Mobility Management Function (AMF).

In some implementations of the method and apparatuses described herein, the remote device is a UE.

Some implementations of the method and apparatuses described herein may further include a method performed by a network entity, the method comprising receiving, from a network function, a security key for a remote device, assigning an IP address to the remote device, associating the security key to the IP address assigned to the remote device, and storing the association of the IP address and the security key.

In some implementations of the method and apparatuses described herein, the method includes receiving, from the remote device, a message requesting setup of a security association, where the message includes the IP address as an identifier for the remote device, and selecting the security key based on the IP address.

In some implementations of the method and apparatuses described herein, the message requesting setup of the security association includes an IKE_INIT message or an IKE-AUTH message.

In some implementations of the method and apparatuses described herein, the message requesting setup includes an anonymous SUCI as the identifier for the remote device that was provided to the network entity during prior EAP-5G signaling.

In some implementations of the method and apparatuses described herein, the network entity is a TNGF of an SNPN.

In some implementations of the method and apparatuses described herein, the network function is an AMF.

In some implementations of the method and apparatuses described herein, the remote device is a UE.

Some implementations of the method and apparatuses described herein may further include a network entity, comprising a processor and a memory coupled with the processor, the processor configured to cause the network entity to receive, from a remote device, an authentication request message, generate a unique identifier for the remote device, transmit, to the remote device, a response message that includes the unique identifier for the remote device, receive, from a network function, a security key for the remote device, associate the security key to the unique identifier assigned to the remote device, and store the association of the unique identifier and the security key.

In some implementations of the method and apparatuses described herein, the processor is further configured to cause the network entity to receive, from the remote device, a message requesting setup of a security association, where the message includes the unique identifier, and select the security key based on the unique identifier.

In some implementations of the method and apparatuses described herein, the authentication request message is an IKE_AUTH message received by the network entity during EAP-5G signaling with the remote device.

In some implementations of the method and apparatuses described herein, the IKE AUTH message includes a NAS (Non Access Stratum) registration request having an anonymous SUCI for the remote device.

In some implementations of the method and apparatuses described herein, the network entity is a non-3GPP Inter-Working Function (N3IWF) of an SNPN.

In some implementations of the method and apparatuses described herein, the network function is an AMF.

In some implementations of the method and apparatuses described herein, the remote device is a UE.

Some implementations of the method and apparatuses described herein may further include a method performed by a network entity, the method comprising receiving, from a remote device an authentication request message, generating a unique identifier for the remote device, transmitting, to the remote device, a response message that includes the unique identifier for the remote device, receiving, from a network function, a security key for the remote device, associating the security key to the unique identifier assigned to the remote device, and storing the association of the unique identifier and the security key.

In some implementations of the method and apparatuses described herein, the method includes receiving, from the remote device, a message requesting setup of a security association, where the message includes the unique identifier, and selecting the security key based on the unique identifier.

In some implementations of the method and apparatuses described herein, the authentication request message is an IKE_AUTH message received by the network entity during EAP-5G signaling with the remote device.

In some implementations of the method and apparatuses described herein, the IKE AUTH message includes a NAS registration request having an anonymous SUCI for the remote device.

In some implementations of the method and apparatuses described herein, the network entity is an N3IWF of an SNPN.

### BRIEF DESCRIPTION OF THE DRAWINGS

FIG. 1 illustrates an example of a wireless communications system that supports providing access to an SNPN for a UE in accordance with aspects of the present disclosure.

FIG. 2 illustrates an example of a diagram that supports a section of a call flow procedure that supports trusted non-3GPP access of an SNPN in accordance with aspects of the present disclosure.

FIG. 3 illustrates an example of a diagram that supports a section of a call flow procedure that supports untrusted non-3GPP access of an SNPN in accordance with aspects of the present disclosure.

FIG. 4 illustrates an example of a block diagram of a device that supports providing access to an SNPN for a UE in accordance with aspects of the present disclosure.

FIG. 5 illustrates a flowchart of a method that supports providing trusted non-3GPP access of an SNPN in accordance with aspects of the present disclosure.

FIG. 6 illustrates a flowchart of a method that supports establishing communications for a UE with an SNPN via trusted non-3GPP access in accordance with aspects of the present disclosure.

FIG. 7 illustrates a flowchart of a method that supports providing untrusted non-3GPP access of an SNPN in accordance with aspects of the present disclosure.

FIG. 8 illustrates a flowchart of a method that supports establishing communications for a UE with an SNPN via untrusted non-3GPP access in accordance with aspects of the present disclosure.

### DETAILED DESCRIPTION

There are various ways to provide non-3GPP access to a SNPN. Many of these ways involve the reuse of procedures that provide trusted and untrusted access within the security architecture of a 5G, or 3GPP, public network. However, these public network procedures do not consider or support use of an anonymous SUCI for a UE.

For example, an anonymous SUCI can have a username format with a string set to “anonymous” and/or an empty username for the UE. Therefore, during an access procedure within an SNPN, a node within the network cannot bind a security to an identity for the UE and cannot correlate communications with the UE, among other drawbacks.

The technology described herein adapts the procedures established for both trusted non-3GPP access and untrusted non-3GPP access. For example, network nodes (e.g., TNGF and N3IWF) can assign or generate an identifier for a UE having an anonymous SUCI as a username during the access procedure. Using the assigned identifier, the network entity can bind the UE to a security key, and communications with the UE within the SNPN can be correlated.

Thus, by utilizing the technology described herein, a network can continue using established access procedures, for both trusted and untrusted non-3GPP access to an SNPN, for all UEs, including those with an anonymous SUCI as a username, among other benefits.

Aspects of the present disclosure are described in the context of a wireless communications system. Aspects of the present disclosure are further illustrated and described with reference to device diagrams and flowcharts.

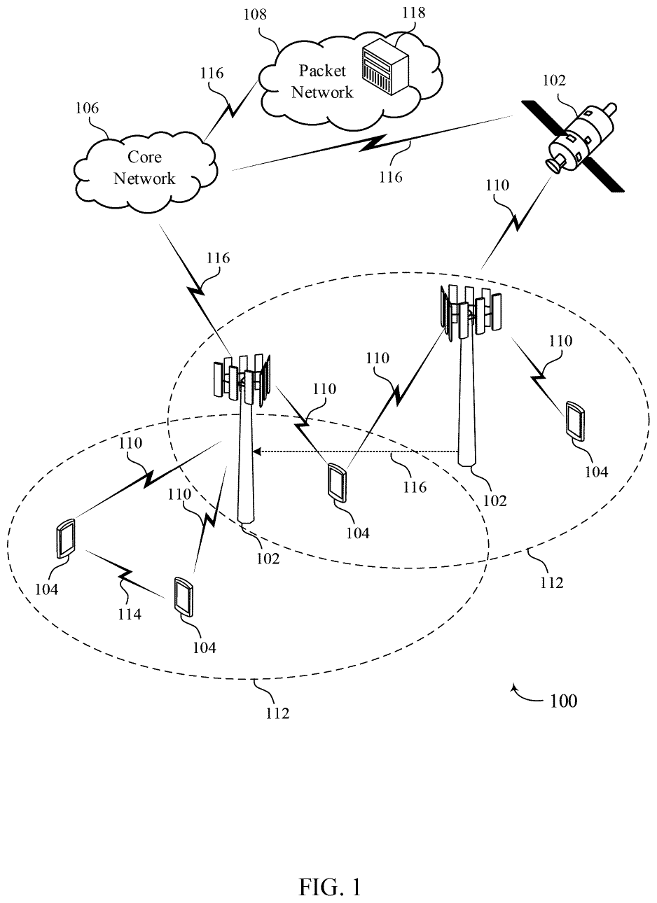

FIG. 1 illustrates an example of a wireless communications system 100 that supports providing access to an SNPN for a UE in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUsor RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the wireless communications system 100 supports the access of a UE (e.g., a user device or remote device), via non-3GPP, to an SNPN, when the UE is associated with an anonymous SUCI. The system 100 supports both trusted and untrusted access by utilizing various network functions to provide or generate unique identifiers for the UE during access procedures.

In some embodiments, a TNGF, during trusted non-3GPP access, assigns the UE 104 a unique IP address within the TNGF. According to RRC 7296, the IP address can be used as an identifier (e.g., implementations of ID_KEY_ID are configurable to include IPv4 and IPv6 addresses).

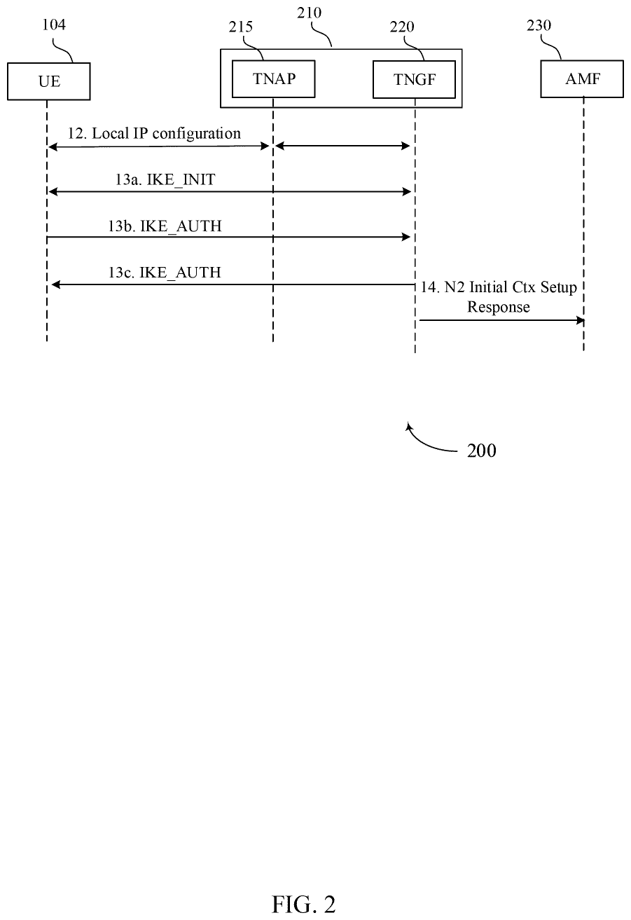

Once the IP address is assigned within the TNGF, both the UE and the TNGF are aware of the IP address. Thus, the network can use an IPv4 or IPv6 address as a unique identifier to locate a corresponding security key (K_{TNGF}). FIG. 2 illustrates an example of a diagram 200 that supports a section of a call flow procedure that supports trusted non-3GPP access of an SNPN in accordance with aspects of the present disclosure. The depicted section of the call flow procedure is based on clause 7A.2.1-1 of TS 33.501, entitled “Registration/Authentication and PDU [protocol data unit] Session establishment for trusted non-3GPP access.”

As shown in FIG. 2, the UE 104 exchanges messages with different network functions to establish a communications session via trusted non-3PP access, including nodes of a Trusted non-3GPP Access Network (TNAN) 210, such as a TNAP (Trusted Non-3GPP Access Point) 215 and a TNGF 220, as well as an AMF (Access and Mobility Management Function) 230. As described herein, modification of a portion of these flows enables the network to support the UE 104, having an anonymous SUCI establishing the communication session with the SNPN.

For example, step 12 of the call flow involves the UE 104 receiving an IP configuration from the TNAN 215 (e.g., with DHCP, or Dynamic Host Configuration Protocol). Here, both the UE 104 and the TNGF 220 have knowledge of the IP configuration (e.g., the IPv4 or IPv6 identifier assigned to the UE 104), which is unique within the TNGF 220.

Then, in step 13, the UE 104 initiates an IKE_INIT exchange with the TNGF 220. The UE 104 received the IP address of the TNGF 220 during EAP-5G signaling in a previous step (e.g., step 9b), and the UE 104 shall initiate an IKE_AUTH exchange and shall include the same UE Id (i.e., SUCI or 5G-GUTI) as in a UE Id provided in step 5.

When the UE 104, in step 5, sends an anonymous SUCI, then the UE 104 shall include the ID IPV4 ADDR or ID_IPV6_ADDR with the assigned IP address in the IDi. The TNGF 220 uses the received IP address to locate the K_{TIPSe} for the connection.

The common K_{TIPSe} is used for mutual authentication (and is derived as specified in Annex A.22 of TS 33.501). NULL encryption can be negotiated as specified in RFC 2410. Next, after step 13c, an IPsec SA is established between the UE 104 and the TNGF 220 (e.g., a NWt connection), which is used to transfer all subsequent NAS messages. This IPsec SA does not apply encryption and instead applies integrity protection.

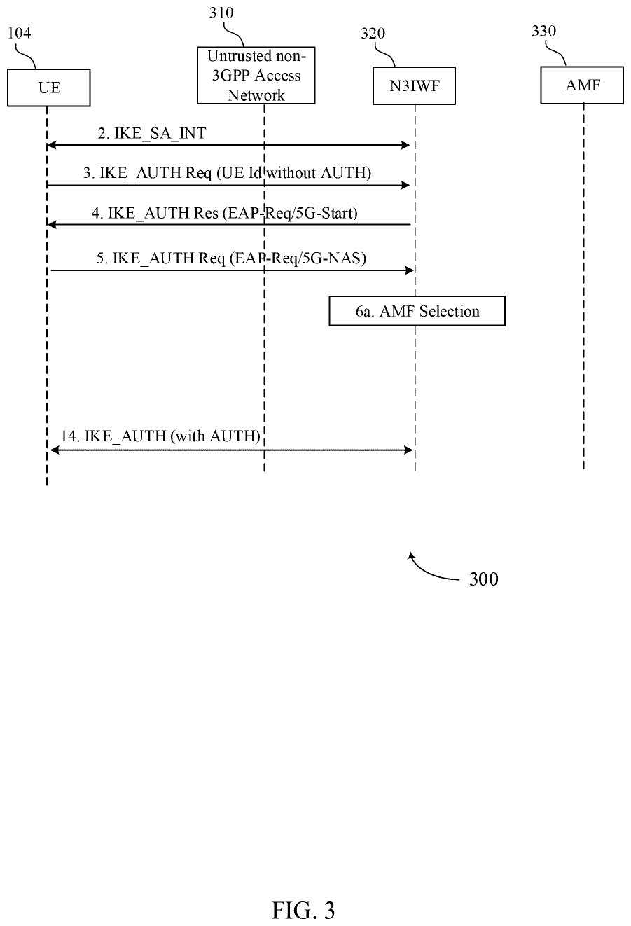

In some embodiments, such as during untrusted non-3GPP access, an N3IWF provides the UE 104 with unique key set identifiers. For example, when the N3IWF receives a NAS Registration Request with an anonymous SUCI, the N3IWF generates a unique identifier for that UE 104 to correlate IKEv2 messages to the particular UE 104. The N3IWF may provide the unique identifier to the UE 104. The UE 104 can then use the identifier when setting up the IPSec SA to guide the N3IWF to select a correct security key (K_{N3IWF}) FIG. 3 illustrates an example of a diagram 300 that supports a section of a call flow procedure that supports untrusted non-3GPP access of an SNPN in accordance with aspects of the present disclosure. The depicted section of the call flow procedure is based on clause 7.2.1 of TS 33.501, entitled “Authentication for Untrusted non-3GPP Access.” The call flow procedure utilizes an “EAP-5G” method between UE 104 and an N3IWF that is utilized for encapsulating NAS messages.

As shown in FIG. 3, the UE 104 exchanges messages with different network functions to establish a communications session via untrusted non-3PP access, including nodes of a TNAN 310, such as an N3IWF 320 and an AMF 330. As described herein, modification of a portion of these flows enables the network to support the UE 104, having an anonymous SUCI, establishing the communication session with the SNPN.

For example, step 3 provides that the UE 104 shall initiate an IKE AUTH exchange by sending an IKE_AUTH request message. The AUTH payload is not included in the IKE_AUTH request message, which indicates that the IKE_AUTH exchange shall use EAP signaling (in this case EAP-5G signaling). The UE 104 shall not use its GUTI/SUCI/SUPI as the Id in this step.

To support use of an anonymous SUCI, the UE ID in the IDi may be replaced by the N3IWF 320 with a unique value (e.g., a counter, some random number that assures uniqueness among all UEs at the N3IWF 320, and so on) as a correlation ID, which binds or associates the communication (such as when an anonymous SUCI is used in step 5). In some cases, the N3IWF 320 may create the correlation ID in step 5 (e.g., when an anonymous SUCI is used).

In step 4, the N3IWF 320 responds with an IKE_AUTH response message, which includes the N3IWF 320 identity, the AUTH payload to protect the previous message it sent to the UE (in the IKE_SA_INIT exchange) and an EAP-Request/5G-Start packet. Following the modification to step 3 herein, the N3IWF 320 may include the correlation ID, in case the UE 104 sends other IKE messages with Idi (e.g., later in step 14 or in any subsequent messages within the call flow).

Next, in step 5, the UE validates an N3IWF certificate and confirms that the N3IWF 320 identity matches the N3IWF 320 selected by the UE 104. The UE 104 shall send an IKE_AUTH request, which includes an EAP-Response/5G-NAS packet that contains a Registration Request message containing UE security capabilities and the SUCI. If an anonymous SUCI is used, then the UE ID in the IDi may be replaced by the N3IWF 320 with a unique value (e.g., a counter, some random number that assures uniqueness among all UEs at the N3IWF 320, and so on) as the correlation ID in order to bind or associate the communication (when the correlation ID was not generated in step 3).

Later, in step 14, an IPsec SA is established between the UE 104 and the N3IWF 320 by using the N3IWF key KN3IWF that was created in the UE 104 using the uplink NAS COUNT associated with NAS connection identifier “0x02” as defined in Annex A.9 of TS 33.501 and was received by N3IWF 320 from the AMF in step 12. When available, the UE 104 can include the correlation ID received from the N3IWF 320 in the IKE AUTH with AUTH message to guide the N3IWF 320 to select the corresponding security key (K_{N3IWF}).

Thus, the technology described herein can support an SNPN, via trusted and/or untrusted non-3GPP access networks, to utilize established access procedures for communication sessions with a UE having an anonymous SUCI as a username.

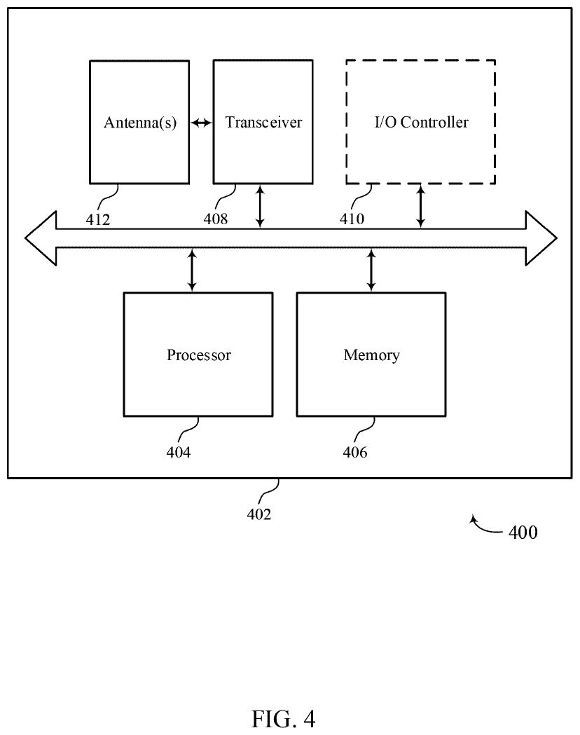

FIG. 4 illustrates an example of a block diagram 400 of a device 402 that supports providing access to an SNPN for a UE in accordance with aspects of the present disclosure. The device 402 may be an example of a network entity 102 as described herein. The device 402 may support wireless communication with one or more network entities 102, UEs 104, or any combination thereof. The device 402 may include components for bi-directional communications including components for transmitting and receiving communications, such as a processor 404, a memory 406, a transceiver 408, and an I/O controller 410. These components may be in electronic communication or otherwise coupled (e.g., operatively, communicatively, functionally, electronically, electrically) via one or more interfaces (e.g., buses).

The processor 404, the memory 406, the transceiver 408, or various combinations thereof or various components thereof may be examples of means for performing various aspects of the present disclosure as described herein. For example, the processor 404, the memory 406, the transceiver 408, or various combinations or components thereof may support a method for performing one or more of the operations described herein.

In some implementations, the processor 404, the memory 406, the transceiver 408, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 404 and the memory 406 coupled with the processor 404 may be configured to perform one or more of the functions described herein (e.g., executing, by the processor 404, instructions stored in the memory 406).

For example, the processor 404 may support wireless communication at the device 402 in accordance with examples as disclosed herein. The processor 404 may be configured as or otherwise support a means for receiving, from a network function, a security key for a remote device, assigning an IP address to the remote device, associating the security key to the IP address assigned to the remote device, and storing the association of the IP address and the security key.

As another example, the processor 404 may support wireless communication at the device 402 in accordance with examples as disclosed herein. The processor 404 may be configured as or otherwise support a means for receiving, from a remote device an authentication request message, generating a unique identifier for the remote device, transmitting, to the remote device, a response message that includes the unique identifier for the remote device, receiving, from a network function, a security key for the remote device, associating the security key to the unique identifier assigned to the remote device, and storing the association of the unique identifier and the security key.

The processor 404 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 404 may be configured to operate a memory array using a memory controller. In some other implementations, a memory controller may be integrated into the processor 404. The processor 404 may be configured to execute computer-readable instructions stored in a memory (e.g., the memory 406) to cause the device 402 to perform various functions of the present disclosure.

The memory 406 may include random access memory (RAM) and read-only memory (ROM). The memory 406 may store computer-readable, computer-executable code including instructions that, when executed by the processor 404 cause the device 402 to perform various functions described herein. The code may be stored in a non-transitory computer-readable medium such as system memory or another type of memory. In some implementations, the code may not be directly executable by the processor 404 but may cause a computer (e.g., when compiled and executed) to perform functions described herein. In some implementations, the memory 406 may include, among other things, a basic I/O system (BIOS) which may control basic hardware or software operation such as the interaction with peripheral components or devices.

The I/O controller 410 may manage input and output signals for the device 402. The I/O controller 410 may also manage peripherals not integrated into the device M02. In some implementations, the I/O controller 410 may represent a physical connection or port to an external peripheral. In some implementations, the I/O controller 410 may utilize an operating system such as iOS®, ANDROID®, MS-DOS®, MS-WINDOWS®, OS/2®, UNIX®, LINUX®, or another known operating system. In some implementations, the I/O controller 410 may be implemented as part of a processor, such as the processor M04. In some implementations, a user may interact with the device 402 via the I/O controller 410 or via hardware components controlled by the I/O controller 410.

In some implementations, the device 402 may include a single antenna 412. However, in some other implementations, the device 402 may have more than one antenna 412 (i.e., multiple antennas), including multiple antenna panels or antenna arrays, which may be capable of concurrently transmitting or receiving multiple wireless transmissions. The transceiver 408 may communicate bi-directionally, via the one or more antennas 412, wired, or wireless links as described herein. For example, the transceiver 408 may represent a wireless transceiver and may communicate bi-directionally with another wireless transceiver. The transceiver 408 may also include a modem to modulate the packets, to provide the modulated packets to one or more antennas 412 for transmission, and to demodulate packets received from the one or more antennas 412.

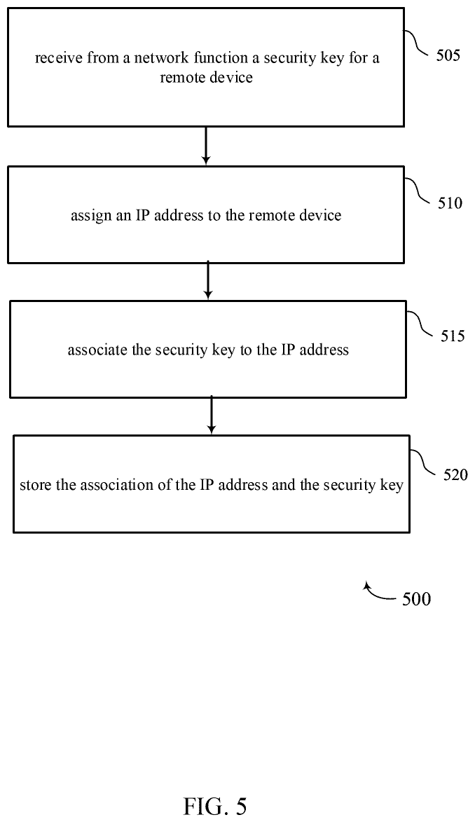

FIG. 5 illustrates a flowchart of a method 500 that supports providing trusted non-3GPP access of an SNPN in accordance with aspects of the present disclosure. The operations of the method 500 may be implemented by a device or its components as described herein. For example, the operations of the method 500 may be performed by the network entity 102 as described with reference to FIGS. 1 through 3. In some implementations, the device may execute a set of instructions to control the function elements of the device to perform the described functions. Additionally, or alternatively, the device may perform aspects of the described functions using special-purpose hardware.

At 505, the method may include receiving, from a network function, a security key for a remote device. The operations of 505 may be performed in accordance with examples as described herein. In some implementations, aspects of the operations of 505 may be performed by a device as described with reference to FIG. 1.

At 510, the method may include assigning an IP address to the remote device. The operations of 510 may be performed in accordance with examples as described herein. In some implementations, aspects of the operations of 510 may be performed by a device as described with reference to FIG. 1.

At 515, the method may include associating the security key to the IP address assigned to the remote device. The operations of 515 may be performed in accordance with examples as described herein. In some implementations, aspects of the operations of 515 may be performed by a device as described with reference to FIG. 1.

At 520, the method may include storing the association of the IP address and the security key. The operations of 520 may be performed in accordance with examples as described herein. In some implementations, aspects of the operations of 520 may be performed by a device as described with reference to FIG. 1.

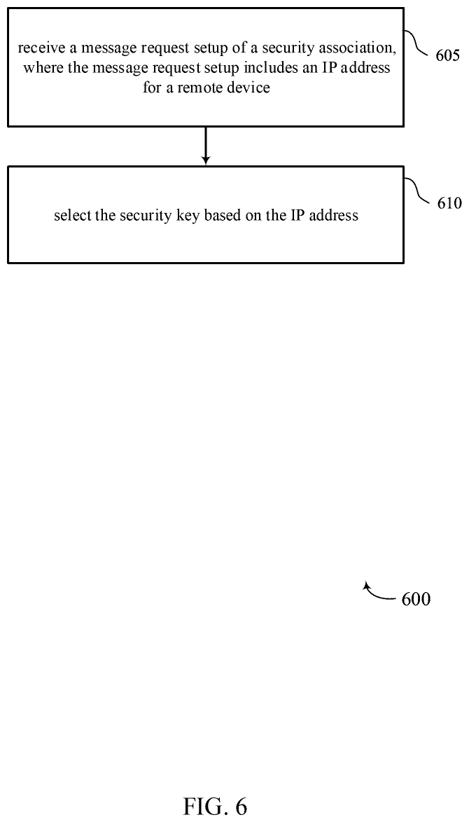

FIG. 6 illustrates a flowchart of a method 600 that supports establishing communications for a UE with an SNPN via trusted non-3GPP access in accordance with aspects of the present disclosure. The operations of the method 600 may be implemented by a device or its components as described herein. For example, the operations of the method 600 may be performed by the network entity 102 as described with reference to FIGS. 1 through 3. In some implementations, the device may execute a set of instructions to control the function elements of the device to perform the described functions. Additionally, or alternatively, the device may perform aspects of the described functions using special-purpose hardware.

At 605, the method may include receiving, from the remote device, a message requesting setup of a security association, where the message includes the IP address as an identifier for the remote device. The operations of 605 may be performed in accordance with examples as described herein. In some implementations, aspects of the operations of 605 may be performed by a device as described with reference to FIG. 1.

At 610, the method may include selecting the security key based on the IP address. The operations of 610 may be performed in accordance with examples as described herein. In some implementations, aspects of the operations of 610 may be performed by a device as described with reference to FIG. 1.

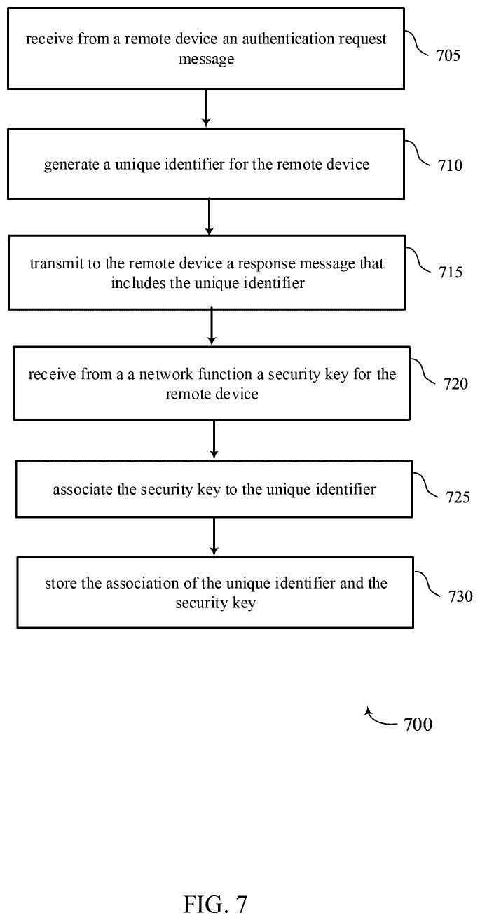

FIG. 7 illustrates a flowchart of a method 700 that supports providing untrusted non-3GPP access of an SNPN in accordance with aspects of the present disclosure. The operations of the method 700 may be implemented by a device or its components as described herein. For example, the operations of the method 700 may be performed by the network entity 102 as described with reference to FIGS. 1 through 3. In some implementations, the device may execute a set of instructions to control the function elements of the device to perform the described functions. Additionally, or alternatively, the device may perform aspects of the described functions using special-purpose hardware.

At 705, the method may include receiving, from a remote device, an authentication request message. The operations of 705 may be performed in accordance with examples as described herein. In some implementations, aspects of the operations of 705 may be performed by a device as described with reference to FIG. 1.

At 710, the method may include generating a unique identifier for the remote device. The operations of 710 may be performed in accordance with examples as described herein. In some implementations, aspects of the operations of 710 may be performed by a device as described with reference to FIG. 1.

At 715, the method may include transmitting, to the remote device, a response message that includes the unique identifier for the remote device. The operations of 715 may be performed in accordance with examples as described herein. In some implementations, aspects of the operations of 715 may be performed by a device as described with reference to FIG. 1.

At 720, the method may include receiving, from a network function, a security key for the remote device. The operations of 720 may be performed in accordance with examples as described herein. In some implementations, aspects of the operations of 720 may be performed by a device as described with reference to FIG. 1.

At 725, the method may include associating the security key to the unique identifier assigned to the remote device. The operations of 725 may be performed in accordance with examples as described herein. In some implementations, aspects of the operations of 725 may be performed by a device as described with reference to FIG. 1.

At 730, the method may include storing the association of the unique identifier and the security key. The operations of 730 may be performed in accordance with examples as described herein. In some implementations, aspects of the operations of 730 may be performed by a device as described with reference to FIG. 1.

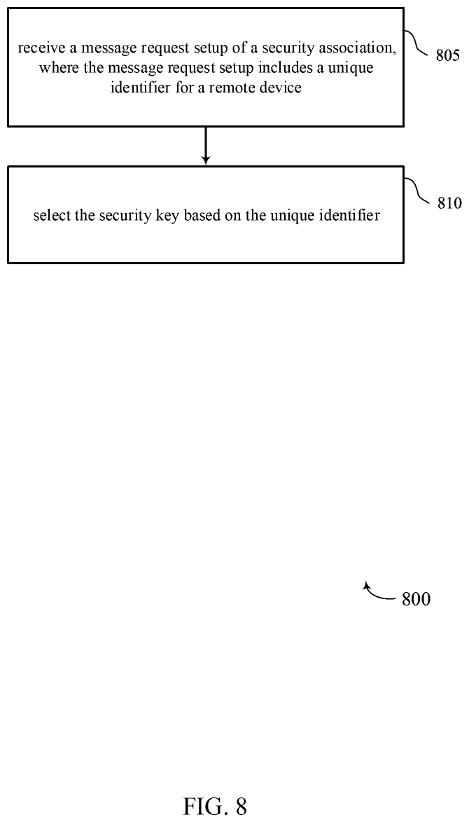

FIG. 8 illustrates a flowchart of a method 800 that supports establishing communications for a UE with an SNPN via untrusted non-3GPP access in accordance with aspects of the present disclosure. The operations of the method 800 may be implemented by a device or its components as described herein. For example, the operations of the method 800 may be performed by the network entity 102 as described with reference to FIGS. 1 through 3. In some implementations, the device may execute a set of instructions to control the function elements of the device to perform the described functions. Additionally, or alternatively, the device may perform aspects of the described functions using special-purpose hardware.

At 805, the method may include receiving, from a remote device, a message requesting setup of a security association, where the message includes a unique identifier. The operations of 805 may be performed in accordance with examples as described herein. In some implementations, aspects of the operations of 805 may be performed by a device as described with reference to FIG. 1.

At 810, the method may include selecting a security key based on the unique identifier. The operations of 810 may be performed in accordance with examples as described herein. In some implementations, aspects of the operations of 810 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A network entity, comprising:
at least one memory; and
at least one processor coupled with the at least one memory and configured to cause the network entity to:
receive, from a network function, a security key for a remote device;
assign an internet protocol (IP) address to the remote device;
associate the security key to the IP address assigned to the remote device; and
store the association of the IP address and the security key.

2. The network entity of claim 1, wherein the at least one processor is further configured to cause the network entity to:
receive, from the remote device, a message requesting setup of a security association, wherein the message includes the IP address as an identifier for the remote device; and
select the security key based on the IP address.

3. The network entity of claim 2, wherein the message requesting setup of the security association includes an IKE_INIT message or an IKE-AUTH message.

4. The network entity of claim 2, wherein the message requesting setup includes an anonymous Subscription Concealed Identifier (SUCI) as the identifier for the remote device that was provided to the network entity during prior EAP-5G (Extensible Authentication Protocol 5G) signaling.

5. The network entity of claim 1, wherein the network entity is a Trusted Non-3GPP Gateway Function (TNGF) of a Stand-alone Non-Public Network (SNPN).

6. The network entity of claim 1, wherein the network function is an Access and Mobility Management Function (AMF).

7. The network entity of claim 1, wherein the remote device is a user equipment (UE).

8. A method performed by a network entity, the method comprising:
receiving, from a network function, a security key for a remote device;
assigning an internet protocol (IP) address to the remote device;
associating the security key to the IP address assigned to the remote device; and
storing the association of the IP address and the security key.

9. The method of claim 8, further comprising:
receiving, from the remote device, a message requesting setup of a security association,
wherein the message includes the IP address as an identifier for the remote device; and
selecting the security key based on the IP address.

10. The method of claim 9, wherein the message requesting setup of the security association includes an IKE_INIT message or an IKE-AUTH message.

11. A network entity, comprising:
at least one memory; and
at least one processor coupled with the at least one memory and configured to cause the network entity to:
receive, from a remote device, an authentication request message;
generate a unique identifier for the remote device;
transmit, to the remote device, a response message that includes the unique identifier for the remote device;
receive, from a network function, a security key for the remote device;
associate the security key to the unique identifier assigned to the remote device; and
store the association of the unique identifier and the security key.

12. The network entity of claim 11, wherein the at least one processor is further configured to cause the network entity to:
receive, from the remote device, a message requesting setup of a security association, wherein the message includes the unique identifier; and
select the security key based on the unique identifier.

13. The network entity of claim 11, wherein the authentication request message is an IKE_AUTH message received by the network entity during EAP-5G (Extensible Authentication Protocol 5G) signaling with the remote device.

14. The network entity of claim 11, wherein the IKE_AUTH message includes a NAS (Non Access Stratum) registration request having an anonymous SUCI (Subscription Concealed Identifier) for the remote device.

15. The network entity of claim 11, wherein the network entity is a non-3GPP Inter-Working Function (N3IWF) of a Stand-alone Non-Public Network (SNPN).

16. The network entity of claim 11, wherein the network function is an Access and Mobility Management Function (AMF).

17. The network entity of claim 11, wherein the remote device is a user equipment (UE).

18. A method performed by a network entity, the method comprising:
receiving, from a remote device an authentication request message;
generating a unique identifier for the remote device;
transmitting, to the remote device, a response message that includes the unique identifier for the remote device;
receiving, from a network function, a security key for the remote device;
associating the security key to the unique identifier assigned to the remote device; and
storing the association of the unique identifier and the security key.

19. The method of claim 18, further comprising:
receiving, from the remote device, a message requesting setup of a security association,
wherein the message includes the unique identifier; and
selecting the security key based on the unique identifier.

20. The method of claim 18, wherein the authentication request message is an IKE_AUTH message received by the network entity during EAP-5G (Extensible Authentication Protocol 5G) signaling with the remote device.
